(19) United States
(12) Patent Application Publication
(10) Pub. No.: US 2026/0095070 A1
(43) Pub. Date: Apr. 2, 2026

(54) SYSTEM FOR INDUCTIVELY TRANSMITTING POWER FROM A PRIMARY DEVICE TO A SECONDARY DEVICE, PRIMARY DEVICE, AND METHOD FOR OPERATING SUCH A SYSTEM

(71) Applicant: Turck Holding GmbH, Halver (DE)

(72) Inventor: Tobias Gerz, Schwarzenberg (DE)

(73) Assignee: Turck Holding GmbH, Halver (DE)

(21) Appl. No.: 19/357,163

(22) Filed: Oct. 14, 2025

Related U.S. Application Data
(63) Continuation of application No. PCT/EP2024/060874, filed on Apr. 22, 2024.

(30) Foreign Application Priority Data
Apr. 25, 2023 (DE) 10 2023 110 452.7

(51) Int. Cl. H02J 50/90; H02J 50/12; H02J 50/60; H02J 50/80

(52) U.S. Cl. CPC H02J 50/90; H02J 50/12; H02J 50/60; H02J 50/80

(57) ABSTRACT

An inductive power transmission system is provided, comprising a primary device; a secondary device; and a control unit; wherein the primary device is arranged and designed to inductively transmit power, via a primary oscillating circuit, to a secondary oscillating circuit of the secondary device during power transmission; wherein the control unit is designed to record secondary power data of the secondary device and a frequency parameter of the primary device; wherein the control unit is designed to determine an actual distance between the primary device and the secondary device based on a distance characteristic field, the recorded secondary power data and the recorded frequency parameter; and wherein the distance characteristic field includes reference secondary power data as a function of reference frequency parameters and as a function of reference distances.

### CROSS REFERENCE TO RELATED APPLICATIONS

This application is a continuation application of international patent application PCT/EP2024/060874, filed on Apr. 22, 2024, and designating the U.S., which claims priority to German patent application 10 2023 110 452.7, filed on Apr. 25, 2023, each of which are hereby incorporated by reference in their entireties.

### TECHNICAL FIELD

The present disclosure concerns a system for inductively transmitting power from a primary device to a secondary device, a primary device and a method for operating a system for inductively transmitting power. The disclosure is therefore in the technical field of the contactless transmission of power (also referred to as Wireless Power Transfer) and inductive couplers.

### BACKGROUND

In some systems power can be transmitted inductively between a primary device (transmitter) and a secondary device (receiver) via an electromagnetic field.

When using such inductive couplers, an important variable can be the axial offset between the transmitter and the receiver, optionally the distance between transmitter and receiver in the axial direction. Knowing this parameter can allow for a potentially more accurate estimation of the power to be applied on the transmitter side, for example, in order to transmit a determined target power to the receiver side by induction.

### SUMMARY

An inductive power transmission system is provided, comprising a primary device; a secondary device; and a control unit; wherein the primary device is arranged and designed to inductively transmit power, via a primary oscillating circuit, to a secondary oscillating circuit of the secondary device during power transmission; wherein the control unit is designed to record secondary power data of the secondary device and a frequency parameter of the primary device; wherein the control unit is designed to determine an actual distance between the primary device and the secondary device based on a distance characteristic field, the recorded secondary power data and the recorded frequency parameter; and wherein the distance characteristic field includes reference secondary power data as a function of reference frequency parameters and as a function of reference distances.

A primary device for inductively transmitting power from the primary device to a secondary device is provided, comprising a control unit and a primary device interface; wherein the control unit is designed to record a frequency parameter of the primary device and to record, via the primary device interface, secondary power data of a secondary device coupled to the primary device for the inductive transmission of power; and wherein the control unit is designed to determine an actual distance between the primary device and the secondary device using a distance characteristic field, the recorded secondary power data and the recorded frequency parameter; and wherein the distance characteristic field includes reference secondary power data as a function of reference frequency parameters and as a function of reference distances.

A method for operating a system for inductively transmitting power from a primary device to a secondary device is provided, comprising recording a frequency parameter of the primary device and secondary power data of the secondary device during power transmission; and determining an actual distance between the primary device and the secondary device using a distance characteristic field, the recorded secondary power data and the frequency parameter; wherein the distance characteristic field includes reference secondary power data as a function of reference frequency parameters and as a function of reference distances.

### BRIEF DESCRIPTION OF THE DRAWINGS

In the drawings:

FIG. 1 shows a schematic depiction of an optional implementation of a system for the inductive transmission of power;

FIG. 2 shows an optional implementation of the method for operating a system for the inductive transmission of power;

FIG. 3 shows an example of recorded data of a power reference measurement at various distances;

FIG. 4 shows an example of a power characteristic determined using the recorded data;

FIG. 5 shows a schematic depiction of an optional implementation of a functional principle for the inductive transmission of power;

FIG. 6 shows an example of recorded data of a distance reference measurement;

FIG. 7 shows an example of power characteristics determined using the recorded data; and

FIG. 8 shows an example of fitted characteristics of a distance characteristic field.

### DETAILED DESCRIPTION

In the following, details are set forth to provide a more thorough explanation of the disclosure. However, it will be apparent to those skilled in the art that these implementations may be practiced without these specific details. In other instances, well-known structures and devices are shown in block diagram form or in a schematic view rather than in detail to avoid obscuring the disclosure. In addition, features described hereinafter may be combined with each other, even if described with respect to different figures, unless specifically noted otherwise.

Equivalent or like elements or elements with equivalent or like functionality are denoted in the following description with equivalent or like reference numerals. As the same or functionally equivalent elements are given the equivalent or like reference numbers in the figures, a repeated description for elements provided with the equivalent or like reference numbers may be omitted. Hence, descriptions provided for elements having the equivalent or like reference numbers are mutually exchangeable.

Directional terminology, such as “top,” “bottom,” “below,” “above,” “front,” “behind,” “back,” “leading,” “trailing,” etc., may be used with reference to the orientation of the figures being described. Because parts of the disclosure, described herein, can be positioned in a number of different orientations, the directional terminology is used for purposes of illustration and is in no way limiting. It is to be understood that other implementations may be utilized, and structural or logical changes may be made without departing from the scope defined by the claims. The following detailed description, therefore, is not to be taken in a limiting sense.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

In implementations described herein or shown in the drawings, any direct electrical connection or coupling, e.g., any connection or coupling without additional intervening elements, may also be implemented by an indirect connection or coupling, e.g., a connection or coupling with one or more additional intervening elements, or vice versa, as long as the general purpose of the connection or coupling, for example, to transmit a certain kind of signal or to transmit a certain kind of information, is essentially maintained. Features from different implementations may be combined to form further implementations. For example, variations or modifications described with respect to one of the implementations may also be applicable to other implementations unless noted to the contrary.

The terms “substantially” and “approximately” may be used herein to account for small manufacturing tolerances (e.g., within 5%) that are deemed acceptable in the industry without departing from the aspects of the implementations described herein. For example, a resistor with an approximate resistance value may practically have a resistance within 5% of that approximate resistance value.

In the present disclosure, expressions including ordinal numbers, such as “first”, “second”, and/or the like, may modify various elements. However, such elements are not limited by the above expressions. For example, the above expressions do not limit the sequence and/or importance of the elements. The above expressions are used merely for the purpose of distinguishing an element from the other elements. For example, a first box and a second box indicate different boxes, although both are boxes. For further example, a first element could be termed a second element, and similarly, a second element could also be termed a first element without departing from the scope of the present disclosure.

One possible object of the present disclosure can be to provide a system for the inductive transmission of power, a primary device and/or a method for operating such a system, wherein the axial offset between transmitter and receiver can be determinable in a simple manner.

The object can be achieved by a system for the inductive transmission of power, which comprises a primary device and a secondary device and a control unit. The primary device can be designed to inductively transmit power, via a primary oscillating circuit, to a secondary oscillating circuit of the secondary device during the power transmission. The control unit can be designed to record secondary power data of the secondary device and a frequency parameter of the primary device. The control unit, using the recorded secondary power data and the frequency parameter, can be furthermore designed to determine an actual distance between the primary device and the secondary device by a distance characteristic field. The distance characteristic field comprises reference secondary power data on the basis of reference frequency parameters and on the basis of reference distances.

A distance characteristic field can be therefore used in the disclosure to be able to determine the distance between primary device and secondary device using the frequency parameter and the recorded secondary power data. Optionally, an axial offset can be assumed, i.e., a distance between transmitter and receiver that can be substantially only in an axial direction, without a simultaneous lateral offset or an angular deviation, for example, as a result of which the primary device and the secondary device are not directly aligned with one another. Such deviations can be taken into account or modeled in further optional implementations of the system.

In one optional implementation, the frequency parameter of the primary device relates to a primary frequency of the primary device, wherein optionally the primary intermediate circuit of the primary device can be operated with a predefined constant primary voltage.

In a further optional implementation, the secondary power data relate to a secondary voltage induced in a secondary intermediate circuit of the secondary device and/or to a secondary current supplied from the secondary intermediate circuit of the secondary device.

Optionally, the distance characteristic field reproduces a correlation between the frequency parameter, optionally the primary frequency of the primary device that can be set for power transmission, and the transmitted secondary power, optionally the secondary voltage of the secondary device, at various distances between the primary device and the secondary device. Depending on the recorded values of the frequency parameter and of the secondary power data, it can be determined which distance this combination of values corresponds to.

The distance characteristic field is, optionally, independent of the primary current intensity adjusted in the primary device. In this way, the distance between primary device and secondary device can be determined without variations in the primary current intensity, for example, having a disruptive effect, such as if a foreign object is present that consumes part of the inductively transmitted power, which in turn leads to a higher necessary primary current intensity.

When defining the axis of an axial offset, it can be assumed that the primary device and the secondary device each have field distributions which are formed in such a way that a maximum inductive transmission of power can be possible, if the primary device and the secondary device are arranged lying above one another along a defined axis.

For example, the primary oscillating circuit and the secondary oscillating circuit have coils which each have a longitudinal axis; for optimal inductive coupling, it can be envisioned that these longitudinal axes are to be arranged lying above one another. For example, the coils of the primary oscillating circuit and of the secondary oscillating circuit are arranged in the extension of their respective coil longitudinal axes. It can be envisioned that the longitudinal axes of the coils correspond to the longitudinal axes of the respective devices, that is to say of the primary device and of the secondary device; however, this can be generally not absolutely necessary.

In a further example, it can be assumed that there are in each case lobe-shaped distributions of the electromagnetic field of the primary device and of the secondary device, such that a maximum inductive transmission of power can take place if the lobes of transmitter and receiver are arranged above one another.

In one optional implementation of the system, the control unit can be incorporated in the primary device. In further optional implementations, it can be incorporated in the secondary device or formed as an external control unit, for example as a control module of a higher-level control system.

The primary power data and secondary power data are recorded in a manner known per se by means of suitable sensors. The measured values can be transmitted to the control unit in various ways.

In a further optional implementation, the control unit can be designed to record the secondary power data via an IO-link connection. Alternatively or additionally, other types of data connection can be provided. The data connection can be between a primary interface of the primary device and a secondary interface of the secondary device.

The IO-link connection or other data connection can be between the primary device and the secondary device, optionally when the control unit can be incorporated in the primary device. In this case, primary power data can be passed directly from a sensor to the control unit and the secondary power data can be transmitted to the control unit via IO-link connection or via another data connection.

In a further optional implementation of the system, a data connection, optionally for transmitting the secondary power data to the primary device, can be realized by modulating a signal for data transmission onto the electromagnetic field for the inductive transmission of power, wherein this makes it possible optionally to transmit data from the primary device to the secondary device.

In a development, the distance characteristic field can be determinable using a distance reference measurement, wherein, in the distance reference measurement, actual secondary power data of the secondary device are measured on the basis of the frequency parameter of the primary device for a plurality of reference distances within a predefined working region between the primary device and the secondary device.

Optionally, the distance characteristic field comprises individual characteristics for various distances which describe the correlation between the frequency parameter and the secondary power data.

Furthermore, it can be envisioned that the parameters of a function are determined by means of a compensation calculation, which function then corresponds to a characteristic of the distance characteristic field or represents the profile of the total distance characteristic field.

In a further optional implementation, the individual characteristics of the distance characteristic field can be established by means of a regression analysis, optionally a linear or polynomial curve fitting, as functions of the measured secondary power data on the basis of the frequency parameter.

Optionally, a compensation calculation can be performed using the least square (LS) method.

For example, in the fit, the parameters of an n-th degree polynomial are established, such as first degree for a linear curve, second degree for a parabola or third degree for a hyperbolic function.

The predefined working region can involve a determined interval of distances and power ranges and/or frequency ranges, for example, within which the inductive transmission of power between the primary device and the secondary device can be operated.

Optionally, the frequency parameter here can be a primary frequency that characterizes the electromagnetic field, generated by the primary device, for the inductive transmission of power.

For example, the primary frequency can be generated by the control unit, for example as a frequency of a square-wave signal. The oscillating circuit of the primary device can be activated alternatingly via power switches of the amplifier circuit. An alternating current therefore arises in the front coil, which alternating current in turn results in an electromagnetic alternating field. The frequency of the electromagnetic alternating field corresponds to the frequency that the control unit outputs.

In a method for determining the distance characteristic field, a distance reference measurement can be performed, wherein actual secondary power data of the secondary device are measured on the basis of a primary frequency of the primary device for a plurality of reference distances within a predefined working region between the primary device and the secondary device.

For example, a primary frequency of the primary device can be measured, which primary frequency can be adjusted at a permanently predefined primary voltage such that a determined reference secondary power can be obtained in the secondary device. This measurement takes place at a fixed distance for a plurality of values of the reference secondary power, such that a curve arises that depicts a correlation between the adjusted primary frequency and the secondary power in each case at a constant distance.

The individual characteristics for various reference distances between the primary device and the secondary device are established, such that a dependency of the to-be-adjusted primary frequency on the distance can be furthermore determined. The reference distances are selected within a predefined working region between the primary device and the secondary device.

The individual established characteristics for various reference distances can be combined to form the distance characteristic field.

A compensation calculation can then be carried out in each case for the curves obtained in this way, to obtain the parameters of a function, for example a linear or other approximation curve, which can then be used as a power characteristic. Furthermore, parameters of a function can also be determined by means of compensation calculation, which function represents the distance characteristic field.

Optionally, the control unit can be furthermore designed to generate an output or a control signal on the basis of the determined actual distance. For example, a determined distance can be output in this way.

Furthermore, on the basis of the determined actual distance, a parameter of the inductive transmission of power can be determined, such as a suitable current and/or a voltage on the part of the primary device, in order to transmit a determined power to the secondary device over this distance. Such a setpoint value can furthermore be used to monitor the integrity of the inductive transmission of power and to detect foreign objects, for example.

A foreign object, optionally an at least partially metal article, counts as detected, for example, if its presence within a transmission region of the system can be discovered. The transmission region can be optionally a space in the surroundings of the primary device, within which space there can be a significant inductive transmission of power onto a metal foreign object, optionally in such a way that it can result in significant heating of the foreign object.

In one optional implementation, the control unit can be furthermore designed to determine primary setpoint power data by means of a power characteristic using the recorded secondary power data and the determined actual distance. The control unit can be furthermore designed to record primary power data of the primary device and to detect a foreign object using a comparison of the primary setpoint power data with the primary power data. The power characteristic comprises reference setpoint power data on the basis of reference secondary power data and on the basis of reference distances.

The power characteristic can be optionally specific for a determined axial offset or axial distance between the primary device and the secondary device. In an additional optional implementation, a position of the devices in relation to one another can furthermore be taken into account, such as an angle of the devices relative to one another and/or a radial offset.

By virtue of the dependency of the power characteristic on the actual distance between primary device and secondary device being taken into account, the primary setpoint power data can be determined more accurately.

The control unit can furthermore be designed to generate and output a switching signal if a foreign object is detected, for example so as to stop the inductive transmission of power by the primary device or to reduce the primary power to a predefined value.

This makes use, inter alia, of the finding that the presence of a foreign object—optionally a metal foreign object—in the region of the inductive transmission of power leads to some of the primary power expended by the primary device being dissipated, for example by heating the foreign object. Nevertheless, in order to obtain a predefined secondary power, a correspondingly higher primary power must consequently be adjusted. In the system, the resulting deviation from the “setpoint” value of the primary power is now to be used to detect the presence of a foreign object.

When there can be a foreign object present in the region of the transmission of power, a higher primary power must therefore be expended in order to provide the same predefined secondary power of the secondary device. A power characteristic can be now used, which indicates a correlation between the secondary power data obtained in the secondary device and the primary setpoint power data to be adjusted on the part of the primary device. The power characteristic can be established optionally in a reference situation in which it can be ensured that no relevant foreign object is present.

In the comparison of the adjusted primary power data with the primary setpoint power data according to the power characteristic, a deviation can be determined, for example, which can be then compared with a threshold value. If the deviation exceeds the threshold value, it can be then assumed that a foreign object can be present. The control unit can now be designed, if a foreign object is detected, to generate a control signal, for example in order to stop the inductive transmission of power by the primary device or to reduce the primary power to a predefined value. Alternatively or additionally, a warning signal can be output.

A threshold value used for the evaluation of the comparison between the primary power data and the primary setpoint power data can be permanently predefined, for example. It can furthermore be determined as a predefined percentage proportion of the primary setpoint power data, for example as a proportion, given as a percentage, of a primary setpoint current intensity, such that the greater a parameter value of the primary setpoint power data, the greater the threshold value for a permissible deviation.

The foreign object can be identified dynamically, that is to say at various distances between primary device and secondary device and at different transmitted powers.

Since, in the system, a foreign object can be detected more precisely than in the known systems—even in a situation in which less power is to be transmitted to the secondary device—heating of metal articles, optionally, can be avoided in the entire power range and distance range of the inductive coupler system. A hazard potential associated therewith can be minimized considerably.

The primary power data or secondary power data, within the meaning of the disclosure, relate to an electrical power in the primary device or secondary device. Correspondingly relevant parameters are, optionally, a current intensity and/or a voltage. The magnitude of the power arises from the product of current intensity and voltage.

For example, the secondary power data comprise a secondary voltage and/or a secondary current intensity; the product of these parameters produces, optionally, the electrical power transmitted inductively to the secondary device. Optionally, the parameters output by an intermediate circuit of the secondary device are taken into account.

The primary power data can also comprise a primary voltage and/or a primary current intensity; the product of these parameters produces, optionally, the power that can be expended in the primary device during the inductive transmission of power to the secondary device. Optionally, the parameters output by an intermediate circuit of the primary device are taken into account.

In one optional implementation of the system, the primary power data relate to a primary current in a primary intermediate circuit of the primary device. Optionally, the primary intermediate circuit of the primary device can be operated with a predefined constant primary voltage.

Furthermore, the secondary power data can relate to a secondary voltage induced in a secondary intermediate circuit of the secondary device and to a secondary current supplied from the secondary intermediate circuit of the secondary device.

In one optional implementation, it can be envisioned that the primary device can be operated with a predefined primary voltage. In such a case, it may be sufficient that the primary power data recorded by the control unit comprise a primary current intensity. Optionally, the primary voltage then does not need to be recorded separately; it can furthermore be taken to be constant for the evaluation.

It can be envisioned optionally that, during the inductive transmission of power—with the primary voltage kept substantially constant—the primary current intensity can be regulated in such a way that predefined secondary power data are obtained.

In further examples, the primary-side voltage can also be regulated. Optionally, the primary-side power, that is to say the product of input current and input voltage, can be then a control variable.

The determined primary setpoint power data also relate optionally to a primary setpoint current intensity.

The control unit of the system accordingly determines the primary setpoint power data by means of a power characteristic and using the recorded secondary power data and using the distance between transmitter and receiver. For example, a primary setpoint current intensity can be determined, wherein it can be assumed optionally that a determined primary voltage can be permanently predefined.

The power characteristic can be saved in a storage device connected to the control unit, for a certain type or model of the system, for example.

In one optional implementation, the power characteristic can be determinable using at least one power reference measurement or using a plurality of power reference measurements. In the power reference measurement, actual primary power data of the primary device are measured on the basis of a plurality of reference secondary power data of the secondary device.

For example, the reference secondary power data can comprise a plurality of parameter values of the secondary power data, which are distributed optionally equidistantly within an interval.

For the power reference measurement, the system or an identical type of system can be measured without a foreign body, for example, wherein, with a predefined primary voltage, the primary frequency of the primary device can be regulated in such a way that a primary current intensity can be set as a control variable, in order to obtain determined values of the secondary power output in the intermediate circuit of the secondary device. These determined values of the secondary power can be arranged equidistantly within an interval in the example; the interval in which the power reference measurements are performed can correspond to an operational range of the electrical power inductively transmitted by means of the system.

Optionally, the reference primary power data are determined using the measured actual primary power data in such a power reference measurement. The data measured in the power reference measurement can additionally be filtered, smoothed and/or processed by means of averaging.

In a development, the actual primary power data are furthermore measured on the basis of a plurality of reference distances within a predefined working region between the primary device and the secondary device in the power reference measurement.

Specific power characteristics are therefore established for the respective distance.

In one optional implementation, the power characteristics are established by means of a regression analysis, optionally a linear or polynomial curve fitting, as a function of the measured actual primary power data on the basis of the reference secondary power data. Optionally, a compensation calculation can be performed using the least square (LS) method. For example, in the fit, the parameters of an n-th degree polynomial are established, such as first degree for a linear curve.

The disclosure furthermore relates to a primary device for inductively transmitting power to a secondary device, wherein the primary device comprises a control unit and a primary device interface. The control unit can be designed to record a frequency parameter of the primary device and to record, via the primary device interface, secondary power data of a secondary device coupled to the primary device for the inductive transmission of power. The control unit can be furthermore designed to determine an actual distance between the primary device and the secondary device by means of a distance characteristic field using the recorded secondary power data and the frequency parameter. The distance characteristic field comprises reference secondary power data on the basis of reference frequency parameters and on the basis of reference distances.

The primary device can be optionally a primary device for the above-described system. The corresponding developments are therefore conceivable.

In the method for operating a system for inductively transmitting power from a primary device to a secondary device, a frequency parameter of the primary device and secondary power data of the secondary device are recorded during the inductive transmission of power. An actual distance between the primary device and the secondary device can be determined by means of a distance characteristic field using the recorded secondary power data and the frequency parameter. The distance characteristic field comprises reference secondary power data on the basis of reference frequency parameters and on the basis of reference distances.

The method can be designed, optionally, to operate the system described here. It therefore can have the same advantages and can be developed in the manner described here.

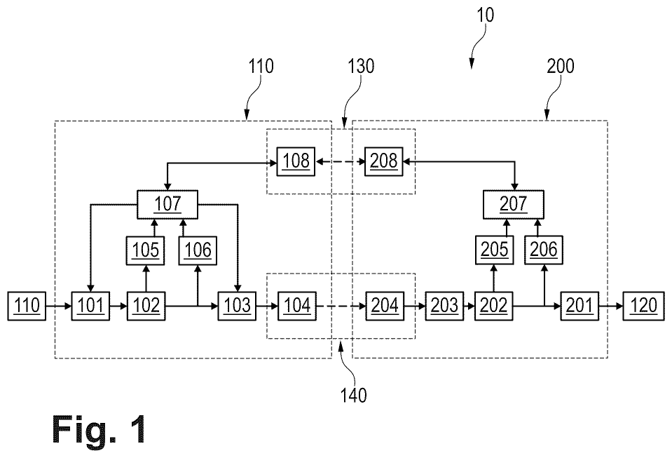

With reference to FIG. 1, an optional implementation of a system 10 for the inductive transmission of power and for detecting a metal object in the electromagnetic field between a primary device 100, here a transmitter 100, and a secondary device 200, here a receiver 200, during contactless transmission of power will be explained.

The system 10 comprises the primary device 100 and the secondary device 200.

In the exemplary optional implementation, the primary device 100 comprises an individual coil 104, located in a (primary) oscillating circuit, for inductively transmitting energy between the coupled primary device 100 and secondary device 200, wherein the primary device 100 adopts the role of the transmitter 100.

Furthermore, it comprises an activation unit 107 for adapting the load-dependent and distance-dependent oscillating circuit frequency and a voltage converter 101 with a constant output voltage and an intermediate voltage circuit 102 for adapting the input voltage to the oscillating circuit voltage.

The primary device 100 furthermore comprises an amplifier 103, optionally a “Current-Mode Class-D Amplifier”, for adapting the control signals of the activation unit 107 to the oscillating circuit with the individual coil 104 and a current measuring unit 106 between the intermediate voltage circuit 102 and an amplifier 103.

The primary device 100 furthermore comprises a voltage measuring unit 105 at the intermediate voltage circuit 102 and an evaluation and activation unit 107 for activating the voltage converter 101 and the amplifier 103.

The primary device 100 furthermore comprises an interface for data transmission 108 between a coupled primary device 100 and secondary device 200, wherein an IO-link method optionally can be used to operate a data connection to the secondary device 200.

The secondary device 200 also comprises an individual coil 204, located in a (secondary) oscillating circuit, for inductively transmitting energy between the coupled primary device 100 and the secondary device 200, wherein the secondary device 200 adopts the role of the receiver 200.

The secondary device furthermore comprises a rectifier 203 with an intermediate voltage circuit 202 for storing the received energy.

The secondary device 200 additionally comprises a voltage converter 201 for adapting the intermediate circuit voltage to the output voltage and a current measuring unit 206 between the intermediate voltage circuit 202 and the voltage converter 201.

The secondary device 200 furthermore comprises a voltage measuring unit 205 at the intermediate voltage circuit 202 and an interface for data transmission 208 between the secondary device 200 and the primary device 100 data-coupled thereto.

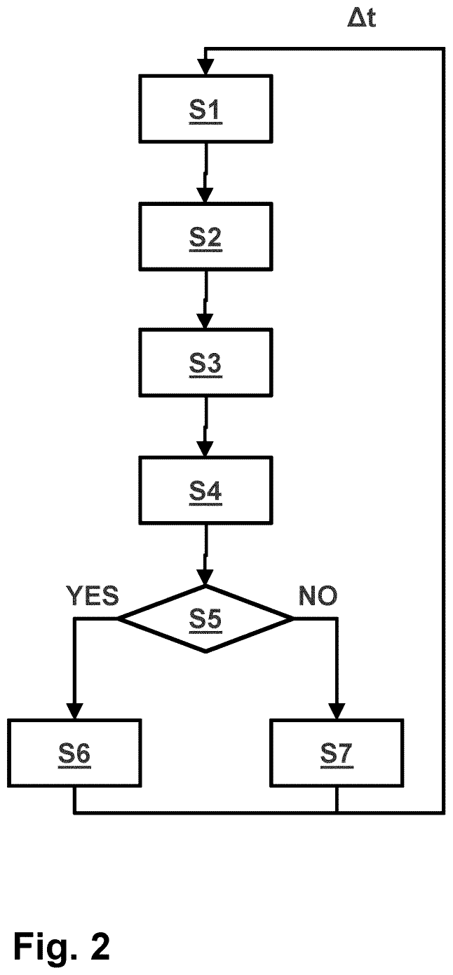

With reference to FIG. 2, furthermore a method for operating the system 10 explained above with reference to FIG. 1 will be explained. The method can be used optionally to detect a foreign object in the region of the electromagnetic field during the inductive transmission of power.

During the transmission of power between primary device 100 and secondary device 200, the intermediate circuit voltage (secondary voltage, U_{sec}) induced in the secondary device 200 and the current (secondary current, I_{sec}) provided from the intermediate circuit 202 of the secondary device 200 is recorded cyclically, in the present example at intervals of Δt=10 ms. These values are transmitted to the corresponding interface 108 of the primary device 100 via the interface 208.

In the optional implementation, a data connection in accordance with IO link is used, but another type of data transmission can also be selected, optionally wired or wire-free. For example, the data can also be transmitted by modulating a carrier signal onto the transmitted electrical power, such that the data and the electrical power are transmitted via the same channel.

From the values recorded in this way, the present power (P_{sec}=U_{sec}·I_{sec}) of the secondary device 200 is determined in a step S1. Furthermore, the present primary current Iₚᵣᵢ is recorded in this step S1.

In a step S2, the recorded data are averaged or smoothed over a determined time interval. This gives averaged values for the primary current I_{pri_avr} and for the secondary power P_{sec_avr}.

In the present example, a distance d between the primary device 100 and the secondary device 200 is assumed, which distance d is in a working range from 0 mm to 7 mm. Furthermore, a load current I_{sec} of the secondary device 200 in a range from 0 mA to 750 mA is assumed in the example. In other examples, other ranges for the distance d and load current I_{sec} may be envisioned.

In the event that there is no metal foreign object located in the electromagnetic field between primary device and secondary device, a ratio-linear in the first approximation-arises between the input current in the resonant circuit of the primary device (primary current, Iₚᵣᵢ) and the secondary output power of the intermediate circuit of the secondary device (secondary power, P_{sec}=U_{sec}·I_{sec}).

This ratio is indicated by means of a power characteristic which is saved in the evaluation and control unit 107 of the primary device 100 and is evaluated thereby. The power characteristic has, for example, the following form:

$${I}_{pri \_ set} = m \cdot {P}_{sec \_ avr} + n$$

In a step S3, during the power transmission, the “setpoint” primary current (setpoint primary current, I_{pri_set}) for the resonant circuit of the primary device 100 is calculated cyclically by means of the power characteristic on the basis of an averaged, that is to say smoothed during the recording, recorded output power of the intermediate circuit 202 of the secondary device 200 (averaged secondary power, P_{sec_avr}). That is to say, the setpoint primary current I_{pri_set} is established, which should be adjusted in accordance with the power characteristic to provide a determined (averaged) secondary power P_{sec_avr}.

This allows for a work-point-accurate evaluation of the actually measured and averaged input current I_{pri_avr} in the resonant circuit of the primary device 100 and of the present calculated “setpoint” input current I_{pri_set} in the resonant circuit of the primary device 100.

A metal foreign object in the electromagnetic field between primary device 100 and secondary device 200 during the inductive transmission of power leads to power being drawn, for example by heating the foreign object. This power is provided by the transmitter 100, but not received by the receiver 200. The primary current I_{pri_avr} must therefore be increased beyond the calculated “setpoint” input current I_{pri_set}, to still provide a determined secondary power.

In a step S4, the calculated primary setpoint input current I_{pri_set} is used to determine a maximum permissible input current I_{pri_max}, which exceeds the calculated setpoint input current I_{pri_set}, for example, by a determined percentage x %:

$${I}_{pri \_ max} = {I}_{pri \_ set} + {I}_{pri \_ set} \cdot x \%$$

The actually recorded primary current I_{pri_avr} is compared with the maximum permissible input current I_{pri_max} and when exceeded, that is to say at this threshold value, that is to say at I_{pri_avr}≥I_{pri_max}, there is an impermissible deviation of the actual averaged input current in the resonant circuit of the primary device 100.

It can be concluded from this, optionally, that a foreign object is present.

In a step S6, a corresponding output is then generated, such as a warning message and/or a switching signal, which aborts the inductive transmission of power, for example.

If the threshold value is not exceeded, that is to say at I_{pri_avr}<I_{pri_max}, no output is generated in a step S7. Alternatively, an output can be generated in order to indicate that no foreign object was detected.

The method is repeated in the loop according to the predefined interval Δt.

The deviation between the measured and the calculated input current into the resonant circuit of the primary device 100 can be evaluated regardless of which working ranges are predefined for the transmittable power and/or the distance between primary device 100 and secondary device 200. The method can be employed for higher secondary powers (such as >18 W) and/or greater distances (such as >7 mm), for example. For this, the power characteristic, optionally, should be determined over the total working ranges used for distance and/or secondary power.

In this respect, the method is easily adaptable for various working ranges of secondary power and of distances, optionally by using power characteristics for corresponding working ranges.

By means of the method, metal deposits on the front cap of one of the primary devices 100 and/or secondary devices 200, for example, can be identified early. Therefore, maintenance work and cleaning work on the coupler system can be arranged in such a way that wear and tear and the energy requirement are reduced.

By safely and rapidly identifying foreign objects, the hazard posed by heated metal articles in the electromagnetic field between primary device 100 and secondary device 200 during the inductive transmission of power is additionally reduced.

The method for dynamically identifying foreign objects will be explained again below in other words.

The method is based on the functional correlation between the input current (I_{pri_set}) into the oscillating circuit of the primary device 100 without foreign object and its regulation in order to obtain, at a predefined primary voltage (Uₚᵣᵢ), a determined secondary output voltage (U_{sec_set}) and a secondary output current (I_{sec_set}_{^{ll}}) at the intermediate voltage circuit 202 of the secondary device 200 without foreign object.

Fct. 1 shows the mentioned functional correlation:

$${I}_{pri \_ set} = f ( {U}_{sec \_ set} , {I}_{sec \_ set} ) \qquad Fct . 1$$

I_{pri_set} [A] input current into the oscillating circuit of the primary device without foreign object
U_{sec_set} [V] voltage at the intermediate circuit capacitor of the secondary device without foreign object
I_{sec_set} [A] current from the intermediate circuit capacitor of the secondary device without foreign object
P_{sec_set} [W] output power from the intermediate voltage circuit of the secondary device without foreign object

The function Fct. 1 can be transformed using the following equation Eq. 1:

$${P}_{sec \_ set} = {U}_{sec \_ set} \cdot {I}_{sec \_ set} \qquad Eq . 1$$

P_{sec_set} [W] output power from the intermediate voltage circuit of the secondary device without foreign object (205, 206)

This gives, for the function Fct. 2, the correlation:

$${I}_{pri \_ set} = f ( {P}_{sec \_ set} ) \qquad Fct . 2$$

Since the voltage converter 101 of the primary device 100 generates a constant output voltage (Uₚᵣᵢ) at the intermediate voltage circuit 102, the output voltage (Uₚᵣᵢ) is not taken into account in the following for the exemplary optional implementation.

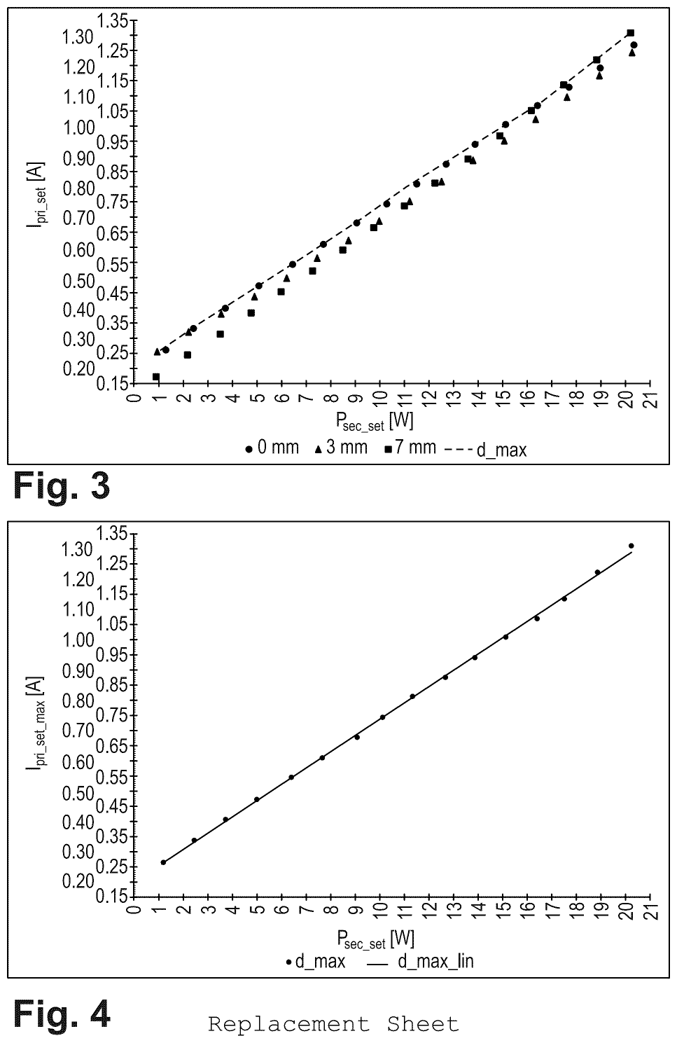

With reference to FIG. 3 and FIG. 4, measurements for establishing a power characteristic will be explained by way of example. In FIG. 3, measurements for distances d of 0 mm, 3 mm and 7 mm between the mutually facing cover caps of the primary device 100 and secondary device 200 are shown for the sake of clarity, but measurements at narrower intervals were undertaken and evaluated.

The measurements of the adjusted actual primary current I_{pri_set} furthermore took place in a range of the secondary output power P_{sec_set} from approximately 1 W to approximately 20 W. A measurement of the correlation of I_{pri_set}=f(P_{sec_set}) therefore takes place over d of 0 mm to 7 mm.

The exemplary method for dynamically identifying foreign objects is based on the assumption that the functional correlation specified in function Fct. 2 can be approximated well as a linear characteristic.

For this purpose, on the basis of the measured function characteristics shown in FIG. 3, the measured maximum value I_{pri_set_max}=f(P_{sec_set_min}) of all the function characteristics taken into account is used for the dependent variable I_{pri_set} from function Fct. 2 at each point on the curve. The distance dependency of the correlation is therefore circumvented by evaluating the highest measured values I_{pri_set} in each case for each value of the secondary power P_{sec_set} as the relevant points of the power characteristic.

These maximum values I_{pri_set_max} are indicated as a dashed line d_max in FIG. 3.

The resulting function characteristic is subsequently linearized, by determining the parameters of a linear fit function by means of compensation calculation, optionally by means of the least square method.

The slope (m) and the displacement constant (n) of the linearized function characteristic are saved as parameters.

In further optional implementations, another function can be used for the fit, such as an n-th order polynomial.

In FIG. 4, the maximum values I_{pri_set_max} are indicated as points d_max and the linearized function I_{pri_set_max}=f(P_{sec_set_min}) is indicated as a continuous curve d_max_lin.

For the maximum values I_{pri_set_max} of the function characteristic profiles from Fct. 2 over the distances d of 0 mm to 7 mm, the following applies:

$${I}_{pri \_ set \_ max} = f ( {P}_{sec \_ set \_ min} ) \qquad Fct . 3$$

I_{pri_set_max} [A] maximum input current into the oscillating circuit of the primary device without foreign object
P_{sec_set_min} [W] minimum output power from the intermediate voltage circuit of the secondary device without foreign object

In addition, the following equation Eq. 2 applies:

$${P}_{sec \_ set \_ min} = {U}_{sec \_ set \_ min} \cdot {I}_{sec \_ set \_ min} \qquad Eq . 2$$

U_{sec_set_min} [V] minimum voltage at the intermediate circuit capacitor of the secondary device without foreign object
I_{sec_set_min} [A] minimum current from the intermediate circuit capacitor of the secondary device without foreign object

The “minimum” voltage or current intensity of the intermediate circuit capacitor of the secondary device are understood to be the respective values which are obtained at least at a predefined primary current I_{pri_set}′. That is to say, the minimum secondary power P_{sec_set_min} achieved in the secondary device and the maximum primary current I_{pri_set}′ expended therefor are correlated. As a result, the power characteristic is determined in such a way that sufficient reserves are provided in any case to attain the desired power by means of the inductive transmission of power.

For the linearization of the function Fct. 3, a fit to an equation as indicated in Eq. 3 is performed:

$${{I}_{pri \_ set}}^{′} = m \cdot {P}_{sec \_ set \_ min} + n \qquad Eq . 3$$

I_{pri_set}′ [A] linearized maximum input current into the oscillating circuit of the primary device without foreign object (106)
m [V−1] slope of the function Fct. 3 (here: 0.053)
n [A] displacement constant of the function Fct. 3 (here: 0.2245)

FIG. 4 shows, by way of example, the linearized function characteristic of the Fct. 3 for the measured maximum values at the distances d of 0 mm to 7 mm. A maximum and linearized power characteristic profile for I_{sec_set_max}=f(P_{sec_set_min}) over d of 0 mm to 7 mm is shown by means of compensation calculation.

If, during the power transmission, there is a metal foreign object located in the electromagnetic field between primary device and secondary device, this generates an impermissible deviation of the input current, calculated on the basis of the Fct. 3, into the oscillating circuit of the primary device (I_{pri_set}′) and is consequently identified as a foreign object.

To calculate the maximum permissible input current into the oscillating circuit of the primary device, the following applies:

$${I}_{pri \_ max} = {{I}_{pri \_ set}}^{′} + {{I}_{pri \_ set}}^{′} \cdot x \% \qquad Eq . 4$$

I_{pri_max} [A] maximum permissible input current into the oscillating circuit of the primary device
I_{pri_set}′ [A] linearized maximum input current into the oscillating circuit of the primary device without foreign object
x % [-] permissible deviation, indicated as a percentage, of the linearized maximum input current into the oscillating circuit of the primary device without foreign object

As becomes clear from the above description, there is a correlation between the primary-side input power Pₚᵣᵢ, to which the input current Iₚᵣᵢ and the input voltage Uₚᵣᵢ held constant in the example, and the secondary-side output power P_{sec}, to which the output current I_{sec} and the output voltage U_{sec} contribute, and the distance d between primary device 100 and secondary device 200. Expressed more simply, the greater the distance d, the more input power Pₚᵣᵢ must be expended on the primary side in order to achieve the same secondary-side output power P_{sec}.

In the procedure illustrated in FIG. 4, the power characteristic is constructed in such a way that the distance d is not taken into account for the comparison with a threshold value of the maximum permissible input current of the primary device.

However, there is a dependency between the setpoint primary power data on the transmitter side, the attained secondary power data on the receiver side and the distance between transmitter and receiver.

In a further exemplary optional implementation, it is therefore envisioned that the axial distance d between the transmitter and the receiver is determined and taken into account in order to determine the setpoint primary power or the maximum permissible primary current. To do this, the appropriate power characteristic is determined using a power characteristic field which comprises power characteristics for various values of the distance d.

Optionally, the measurements, shown in FIG. 3, of the values of the adjusted actual primary current I_{pri_set} are evaluated on the basis of the secondary output power P_{sec_set} at various distances d. For each distance d or for a determined range of distances, a separate power characteristic is determined by means of a compensation calculation and fitted to an n-th order polynomial or to another suitable function by means of compensation calculation.

The power characteristics recorded for various distances d now form a distance characteristic field.

To evaluate this distance characteristic field, the required secondary-side output power and the distance d must now be recorded. The power characteristic appropriate for the distance d is then determined and, using this power characteristic, the setpoint primary power data are determined, in the example therefore the maximum primary-side input current, wherein a permanently predefined primary-side input voltage is assumed here.

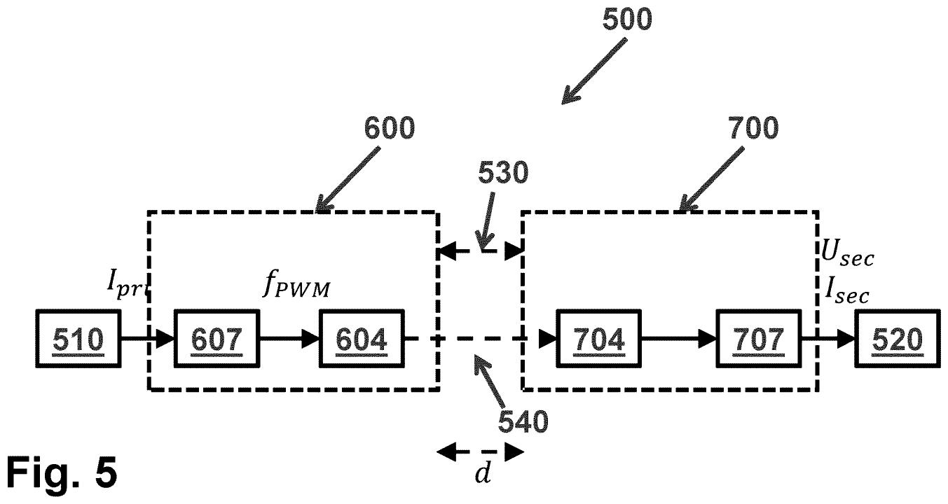

With reference to FIG. 5, the determination of the axial distance between the primary device and the secondary device will be explained below. The system 500 shown here corresponds substantially to the system that was already explained above with reference to FIG. 1. All the elements will therefore not be described in detail again.

The system 500 for the inductive transmission of power comprises a primary device 600 and a secondary device 700. The control unit is not shown separately here, but it is intended to be incorporated in the primary device 600.

During an inductive transmission of power, an activation unit 607 of the primary device 600 is fed by a source 510 with a primary current intensity Iₚᵣᵢ.

The activation unit 607 then provides a pulse-width-modulated signal f_{PWM} in order to activate an oscillating circuit 504. As a result, a primary-side frequency of 105.0 to 129.5 kHz is achieved in the exemplary optional implementation.

Power transmission 540 takes place from the primary-side oscillating circuit 604 to a secondary-side oscillating circuit 704.

Parallel to this, data transmission 530 is implemented between the primary device 600 and the secondary device 700, wherein an IO-link connection is provided in the example; in further optional implementations, alternatively or additionally, other data connections can be provided.

The alternating voltage induced in the oscillating circuit 704 of the secondary device 700 depends on the distance d between the primary device 600 and the secondary device 700.

A direct voltage U_{sec} is then generated by a rectifier 707 at an intermediate circuit capacitor of the secondary device 700 by means of this induced alternating voltage.

As soon as power is output from the secondary device 700 to a load 520, a measurable secondary current I_{sec} flows from the intermediate circuit capacitor.

The present values for the secondary current I_{sec} and the secondary voltage U_{sec} are measured and transmitted to the primary device 600 via the data transmission 530. Within the limits of the frequency of the PWM activation signal f_{PWM}, the primary device 600 regulates the intermediate circuit voltage U_{sec} of the secondary device 700 to a desired value, 24 V in the exemplary optional implementation.

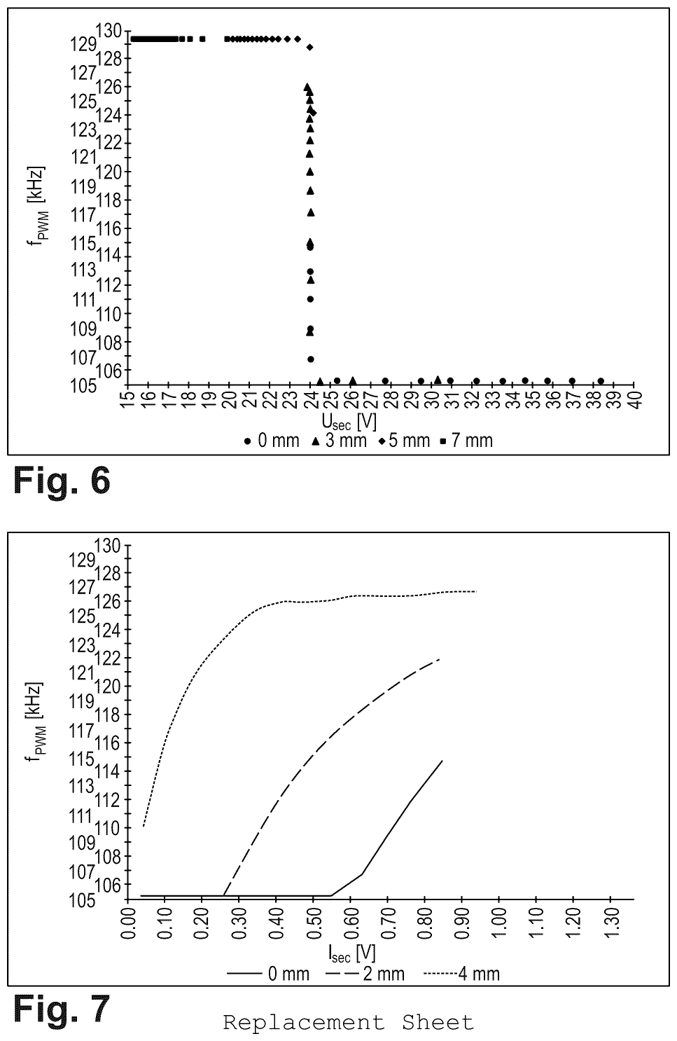

The graph shown in FIG. 6 illustrates, by way of example, a functional correlation between the frequency of the PWM activation signal f_{PWM} of the primary device 600 and the intermediate circuit voltage U_{sec} of the secondary device 700.

Furthermore, the graph shown in FIG. 7 illustrates, by way of example, a functional correlation between the frequency of the PWM activation signal f_{PWM} of the primary device 600 and the secondary current I_{sec} of the secondary device 700. Curves of measurements at various distances d, here 0 mm, 2 mm and 4 mm, are in this graph.

To be able to better evaluate these curves, the secondary power P_{sec}=I_{sec}·U_{sec} is plotted on the X-axis and the value of f_{PWM}·I_{sec}·z is plotted on the Y-axis, wherein the factor z=a·xⁿ is determined with a constant a=30 and a parameter x=P_{sec}=I_{sec}·U_{sec} with the exponent n=−1. In this example, this gives the following transformation for the values of the Y-axis:

$${f}_{PWM} \cdot {I}_{sec} \cdot z = {f}_{PWM} \cdot {I}_{sec} \cdot a \cdot {x}^{n} = {f}_{PWM} \cdot {I}_{sec} \cdot 30 \cdot {( {I}_{sec} \cdot {U}_{sec} )}^{- 1} = 30 \cdot \frac{{f}_{PWM}}{{U}_{sec}}$$

That is to say, the curves shown in FIG. 7 show the correlation of the value f_{PWM}/U_{sec} on the basis of the secondary power P_{sec} for various distances d.

In a further step, the curves measured for the distances d can be fitted by means of a compensation calculation, wherein the parameters of a third-order polynomial, for example, are determined. In the example, in this way the constants (k1, k2, k3, k4) are for a polynomial of the form:

$$Poly 3 ( {f}_{PWM} \cdot {I}_{sec} \cdot z ) = f ( {P}_{sec} ) = k 1 \cdot {{P}_{sec}}^{3} + k 2 \cdot {{P}_{sec}}^{2} + k 3 \cdot {P}_{sec} + k 4$$

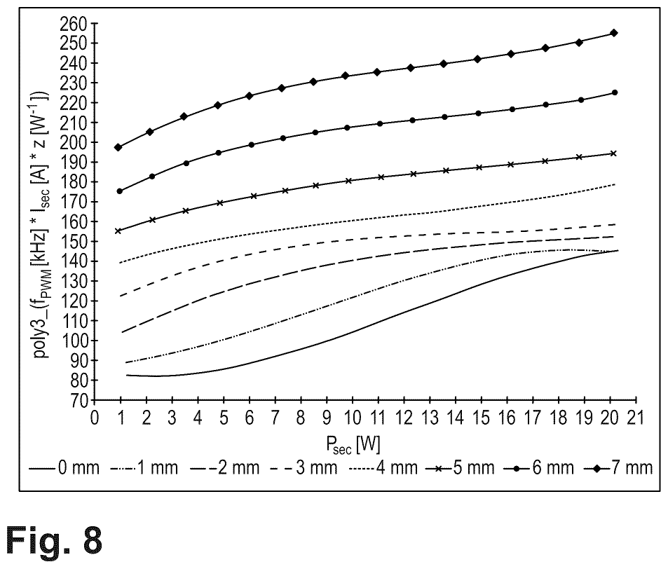

The profiles of such characteristics for the distances d between 0 mm and 7 mm are shown by way of example in FIG. 8. In the exemplary optional implementation, these characteristics form the distance characteristic field for various distances d.

To now determine a distance between the transmitter 100, 600 and the receiver 200, 700, the primary frequency f_{PWM} of the primary device 100, 600 and the secondary power P_{sec} obtained by the intermediate circuit of the secondary device 200, 700 are recorded.

Optionally, the secondary power P_{sec} is transmitted from the secondary device 200, 700 to the primary device 100, 600 via the data connection 530, such as an IO-link connection.

It can now be determined which one of the characteristics of the distance characteristic field most closely matches the measured value pair. The corresponding distance d is then output and can be used in the detection of foreign bodies, for example.

In further optional implementations, the characteristics of the distance characteristic field can be formed in another way. The fundamental idea in this regard consists of the fact that the characteristics represent a correlation between the primary frequency f_{PWM} of the primary device 100, 600 and the secondary power P_{sec} obtained by the intermediate circuit of the secondary device 200, 700 for various distances d. These parameters are recorded during the inductive transmission of power and a check is made to determine which characteristic corresponds most closely to the recorded value pair. The corresponding distance d can then be specified.

### LIST OF REFERENCE CHARACTERS

10 system
100 primary device; transmitter
101 voltage converter
102 intermediate voltage circuit; primary intermediate circuit
103 amplifier
104 individual coil
105 voltage measuring unit
106 current measuring unit
107 evaluation and activation unit
108 primary interface; interface (data transmission)
110 input
120 output
130 data transmission
140 power transmission
200 secondary device; receiver
201 voltage converter
202 intermediate voltage circuit; secondary intermediate circuit
203 rectifier
204 individual coil
205 voltage measuring unit
206 current measuring unit
207 evaluation and activation unit
208 secondary interface; interface (data transmission)
500 system
510 source
520 load
530 data connection
540 power transmission
600 primary device
604 primary oscillating circuit
607 activation unit
700 secondary device
704 secondary oscillating circuit
707 rectifier
d distance
S1, S2, S3, S4, S5, S6, S7 step

What is claimed is:

1. An inductive power transmission system, comprising:
a primary device;
a secondary device; and
a control unit;
wherein the primary device is arranged and designed to inductively transmit power, via a primary oscillating circuit, to a secondary oscillating circuit of the secondary device during power transmission;
wherein the control unit is designed to record secondary power data of the secondary device and a frequency parameter of the primary device;
wherein the control unit is designed to determine an actual distance between the primary device and the secondary device based on a distance characteristic field, the recorded secondary power data and the recorded frequency parameter; and
wherein the distance characteristic field includes reference secondary power data as a function of reference frequency parameters and as a function of reference distances.

2. The system according to claim 1, wherein the frequency parameter of the primary device relates to a primary frequency of the primary device.

3. The system according to claim 1, wherein the secondary power data relate to at least one of a secondary voltage induced in a secondary intermediate circuit of the secondary device, and to a secondary current supplied from the secondary intermediate circuit of the secondary device.

4. The system according to claim 1, wherein the control unit is incorporated in the primary device.

5. The system according to claim 1, wherein the control unit is designed to record the secondary power data via an IO-link connection.

6. The system according to claim 1, wherein the distance characteristic field is determinable using a distance reference measurement; wherein, in the distance reference measurement, actual secondary power data of the secondary device are measured based on the frequency parameter of the primary device for a plurality of reference distances within a predefined working region between the primary device and the secondary device.

7. The system according to claim 6, wherein characteristics of the distance characteristic field are established using a regression analysis as functions of the measured secondary power data based on the frequency parameter.

8. The system according to claim 1, wherein the control unit is designed to determine primary setpoint power data by means of a power characteristic using the recorded secondary power data and the determined actual distance; wherein the power characteristic comprises reference setpoint power data based on reference secondary power data and based on reference distances; and wherein the control unit is designed to record primary power data of the primary device and to detect a foreign object using a comparison of the primary setpoint power data with the primary power data.

9. The system according to claim 8, wherein the power characteristic is determinable using a power reference measurement; wherein, in the power reference measurement, actual primary power data of the primary device are measured based on a plurality of reference secondary power data of the secondary device.

10. A primary device for inductively transmitting power from the primary device to a secondary device, comprising:
a control unit and a primary device interface;
wherein the control unit is designed to record a frequency parameter of the primary device and to record, via the primary device interface, secondary power data of a secondary device coupled to the primary device for inductively transmitting power;
wherein the control unit is designed to determine an actual distance between the primary device and the secondary device using a distance characteristic field, the recorded secondary power data and the recorded frequency parameter; and
wherein the distance characteristic field includes reference secondary power data as a function of reference frequency parameters and as a function of reference distances.

11. A method for operating a system for inductively transmitting power from a primary device to a secondary device; comprising:
recording a frequency parameter of the primary device and secondary power data of the secondary device during power transmission; and
determining an actual distance between the primary device and the secondary device using a distance characteristic field, the recorded secondary power data and the frequency parameter;
wherein the distance characteristic field includes reference secondary power data as a function of reference frequency parameters and as a function of reference distances.
